(19) United States
(12) Patent Application Publication
(10) Pub. No.: US 2011/0067953 A1
(43) Pub. Date: Mar. 24, 2011

(54) Extraction Device

(76) Inventor: Christopher Kopp, Winnipeg (CA)

(21) Appl. No.: 11/622,544

(22) Filed: Jan. 12, 2007

Related U.S. Application Data
(60) Provisional application No. 60/775,323, filed on Feb. 22, 2006.

(51) Int. Cl. A62B 35/00; A62B 1/16

(52) U.S. Cl. 182/3; 182/230

(57) ABSTRACT

An extraction device comprises a sling comprising a preformed closed loop of adaptable size and a tightening element extending from the preformed loop, pulling of which reduces the loop size. A sliding connection connects the sling to a flexible line having two attachment elements disposed at opposite ends thereof. An extraction garment comprises a belt and a distal attachment point supported an outward distance from the belt for selective connection to the attachment element to facilitate hands-free pulling. The preformed loop can be easily disposed about a casualty and tightened with one hand, leaving the rescuer's other hand free. The sliding connection automatically adjusts the connection point between the sling and flexible line in response to pulling force(s) exerted on the end(s) of the flexible line. The distal attachment point of the extraction garment reduces tendency for the belt to twist under loading.

This application claims the benefit under 35 U.S.C. 119(e) of U.S. provisional application Ser. No. 60/775,323, filed Feb. 22, 2006.

### FIELD OF THE INVENTION

This invention relates to an extraction device for withdrawing a casualty from a hazardous environment.

### BACKGROUND OF THE INVENTION

In removal of a casualty from a hazardous environment, it is important to be able to perform the withdrawal quickly and safely to reduce the risk of further injury, either to the initial casualty or to the rescuer(s). As an example, such removal is often necessary in tactical or operational situations where rescuers may find themselves under fire from armed opposition.

As an example of existing methods for extracting a casualty from an unsafe area, a plurality of rescuers may crouch in a line formation behind a shield carried by the first in line and approach the casualty. The first in line passes the casualty so that those behind him may lift the casualty from the ground and carry him as the line reverses direction to exit the area. Such procedures in which a line or cluster of rescuers are crouched for protection behind one or more carried shields are slow to carry out and also expose a relatively high number of rescuers to significant risk of injury or fatality.

Rescue slings have been developed which allow extraction to be performed by armed rescuers who can substantially maintain a weapon in a useful position to ward off attack by armed opposition. An example of such a sling is the Sav-A-Jake which features two fixed loops connected to a strap having a carabiner at an opposite end. Each loop can be pulled by one hand of a rescuer, leaving the other hand free to carry a small weapon, such as a hand gun, once the carabiner has been either connected to a suitable attachment point on the casualty or folded back over the strap and engaged thereto to form a loop around the casualty. Alternatively, the carabiner may be clipped to a suitable attachment point on a rescuer while the loops are engaged around appendages of the casualty. While this facilitates rescue by an individual and hands-free pulling of the casualty from the area, the fixed loops may slip off the casualty and halt the extraction. Forming a tightenable loop with the strap and carabiner around the casualty allows prevents disconnection from the sling, but may be difficult to perform with one hand. Used this way, the carabiner would not be free for attachment to the rescuer to faciliate hands-free pulling.

Hands free pulling of the tightenable loop may be possible with the connection of a second strap and carabiner assembly to the device. The addition of such an assembly may increase the size and cost of the device. Making such an assembly detachable from the device allows the weight and size of the device to be kept down when the second assembly isn't needed, but may result in loss or misplacement thereof.

### SUMMARY OF THE INVENTION

According to a first aspect of the invention there is provided an extraction device comprising:

a sling comprising:
a preformed loop of adaptable size; and
a tightening element connected to and extending from the preformed loop;

the preformed loop being reducible in size by pulling of the tightening element.

The preformed loop can be easily disposed about a casualty and tightened with one hand, leaving the rescuer's other hand free.

Preferably the closed loop is substantially manually unopenable.

Preferably the closed loop is closed by a substantially rigid member.

Preferably the preformed loop is defined by a first end of the sling folded toward an opposite second end and adapted for sliding engagement along the sling.

Preferably the sliding engagement is provided by a substantially rigid member supported at the first end of the sling defining an opening through which the sling passes.

Preferably there is provided a blocking element supported at the second end of the sling, the blocking element being greater in size than the opening.

Preferably there is provided at least one attachment element connected to the sling.

Preferably the at least one attachment element is openable. For example, the attachment element may be a carabiner which may be coated in plastice to reduce noise compared to the metal-on-metal sound associated with connection of a typical metal carabiner with a metal connection ring.

Preferably the sling is foldable into a storage condition from which the sling is deployable by pulling of the preformed loop.

Preferably there is provided at least one elastic member engagable about the sling when folded into the storage condition.

Preferably the sling and the at least one attachment element are foldable over one another into a storage condition from which the sling and the at least one attachment element are deployable by pulling of the preformed loop.

Preferably there is provided at least one elastic member connected to the at least one attachment element, the at least one elastic member being operable to secure the sling and the at least one attachment element in the storage condition.

There may be provided a wearable garment wherein a respective one of the at least one attachment element is connectable to the garment to facilitate hands-free pulling of the sling. In this case, preferably the garment comprises a belt and a distal attachment point for connection to the sling at a distance outward from the belt. In this case, preferably the distal attachment point is supported for motion between a storage position adjacent the belt and a deployed position spaced outwardly therefrom. The distal attachment point of the extraction garment reduces tendency for the belt to twist under loading.

There may be provided two attachment elements disposed at opposite ends of a flexible line, wherein the sling comprises a sliding connector engaged to the flexible line and slidable therealong.

According to a second aspect of the invention there is provided an extraction device comprising:

a rescue line;

a flexible line having two attachment elements disposed at opposite ends thereof; and

a sliding connection provided between the rescue line and the flexible line to allow sliding along the flexible line of a point at which the flexible line and the rescue line are connected.

The sliding connection automatically adjusts the connection point between the sling and flexible line in response to pulling force(s) exerted on the end(s) of the flexible line.

The flexible line may be adjustable to change a distance between the two attachment elements measured along the flexible line.

According to a third aspect of the invention there is provided an extraction device comprising:

a rescue line;

an attachment element connected to the rescue line; and

an extraction garment comprising:
a belt; and
a distal attachment point supported an outward distance from the belt for selective connection to the attachment element to facilitate hands-free pulling of the line.

Preferably the garment comprises additional attachment points provided on front and rear portions of the belt for selective connection to the attachment element.

The additional attachment points may be supported to hang below the belt.

The belt may have an outer surface and comprise one of a hook element or a loop element of a hook and loop fastener disposed on said outer surface.

The rescue line may comprise a strap and/or a sling.

### BRIEF DESCRIPTION OF THE DRAWINGS

In the accompanying drawings, which illustrate exemplary embodiments of the present invention:

FIG. 1 is a perspective view of an extraction device featuring a belt and a sling connected by attachment elements in accordance with a first embodiment.

FIG. 2 is an overhead plan view of the sling of FIG. 1 in a deployed condition.

FIG. 3 is a perspective view of the sling of FIG. 1 folded into a storage condition.

FIG. 4 is a perspective view of the belt of FIG. 1 with a pop out ring supported on the belt in a deployed position.

FIG. 5 is a perspective view of the belt of FIG. 1 with the pop out ring supported on the belt in a storage position.

FIG. 6 is a partial perspective view of a second strap of a sling in accordance with a second embodiment showing a first end of the second strap.

FIG. 7 is a partial perspective view of the second strap of the sling of the second embodiment showing a second end of the second strap opposite the first end shown in FIG. 6.

FIG. 8 is an overhead plan view of the second embodiment components shown in FIG. 6.

### DETAILED DESCRIPTION

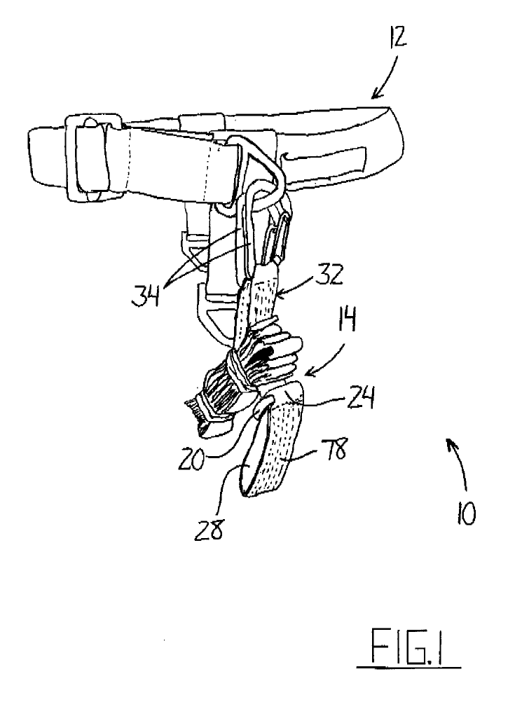

FIG. 1 shows an extraction device 10 according to a first embodiment of the present invention featuring a wearable belt 12 connected to a sling 14. The belt 12 can be worn by a rescuer who can pull a casualty out of a hazardous region once having secured the sling 14 to the user. In FIG. 1, the sling 14 is shown folded into a compact storage condition and hung from the belt 12 by attachment elements. The connection of the sling 14 to the wearable belt 12 allows hands free carrying when the sling 14 is not in use and also facilitates hands free pulling of a casualty supported by the sling in an emergency situation.

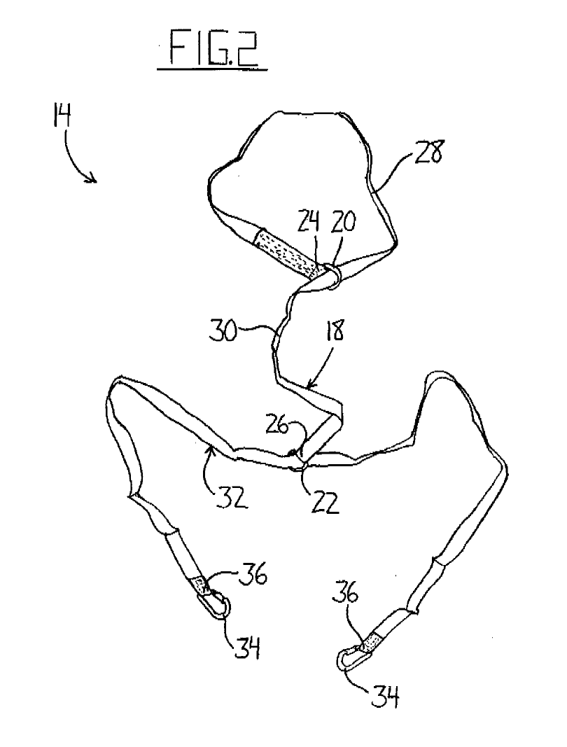

FIG. 2 shows the sling 14 in a deployed condition ready for use. The sling 14 features a first flexible strap 18 having D-rings 20, 22 supported at its opposite ends 24, 26. Each D-ring is supported in a conventional manner known to those of skill in the art by stitching a fold at the respective end of the first strap about a straight portion of the ring. At the first end 24, the first strap 18 has been folded back over itself toward the second end 26 in order to form a loop 28. D-ring 20 extends about the first strap 18 between its ends to close the loop 28 and is slidable along the first strap 18 to change the size of the loop 28. A tightening element 30 is defined by a remaining portion of the first strap 18 not used to form the loop 28. In other words, the tightening element 30 is the length of strap disposed on a side of the D-ring 20 opposite the loop 28. Thus, pulling the tightening element 30 increases its own length and correspondingly decreases the size of the loop 28 by passing a portion of the first strap 18 through D-ring 20.

D-rings 20 and 22 are rigid and sized such that one cannot pass through the opening of another, thereby ensuring that the strap 18 always defines a loop as the rings cannot be opened without breaking and end 26 of the strap cannot pass through D-ring 20. The strap 18 therefore provides a preformed loop of adjustable size that, even with only one hand free, can be easily slipped around a limb of a casualty and tightened.

A second flexible strap 32 having carabiners 34 supported at opposite ends 36 passes through D-ring 22 at the second end 26 of the first strap 18. Like the D-rings on the first strap, each carabiner 34 is supported on the second strap 32 by having folded the respective end 36 over itself and about a portion of the caribiner 34 and stitched it in place. The connected carabiners 34 act as attachment elements for connecting the sling 14 to the belt 12. D-ring 22 is sized such that neither carabiner is passable therethrough. As a result, if only one of the two carabiners 34 is attached to a rescuer, pulling will cause the second strap 32 to pass through D-ring 22 until the other carabiner engages therewith, at which time the first strap 18 will be pulled by the second strap 32. With the loop 28 tightened around a casualty and a carabiner attached to the belt 12 of a rescuer, the rescuer can simply drag the casualty along the ground for fast removal from the area. As the rescuer does not need to use either hand to pull the sling 12, both hands remain free to hold a weapon, shield or other device suitable for the particular situation. Having carabiners 34 on opposite sides of D-ring 22 connected by a single strap and each being larger than the D-ring's opening prevents separation of the first and second straps so that components do not become lost or misplaced. A rescuer possessing the loop 28 will therefore automatically have possession of the attachment elements 34.

The load of a casualty received in the sizable loop 28 can be shared between two rescuers, each having one of the carabiners connected thereto. The D-ring 22 fitted about the second strap 32 acts as a slidable connection defining a movable connection point between the first and second straps that is displaceable along the second strap in response to pulling of either carabiner relative to the loop. The system thereby automatically shifts the point along the second strap at which the first strap, or sling, and the casualty secured thereto are pulled in response to the pulling force(s) exerted at the end(s) of the second strap.

In the case where the casualty is wearing the belt 12 of the present invention, or another article having a suitable connection point, a rescuer can simply connect the second strap 32 directly between the two of them without use of the loop 28. The sling 14 allows a rescuer to choose either the tightenable loop 28 or the free carabiner 34 for connection to the casualty depending on which is better suited for this situation. For example, should the casualty be wearing specialized equipment with a suitable anchor point and be positioned for easy access to that point, then the carabiner would likely be the fastest option. However should the casualty not be so equipped or positioned, then the loop 28 must be used, but its preformed and tightenable structure will provide fast and secure engagement with the casualty.

The belt 12 is worn in a conventional manner by extending the belt strap 40 around a user such that the inner surface 42 fits around the body near the waist area to support the belt thereon. The belt 12 is closed by a buckle 44 that is supported at a closure point 46 of the belt strap 40 and features a square ring 48 and a vertical cross member 50 supported for horizontal sliding motion within the square ring. To close the belt 12 for wearing, an end 52 of the belt strap 40 is passed through the ring, folded around the cross member 50 and pulled back through the ring 48. Pulling the belt strap 40 around the cross member 50 by the end 52 tightens the belt 12 to fit snuggly on the user.

A folded portion 54 of the belt strap 40, defined between the buckle cross member 50 and the end 52 with the belt closed, is engaged to a portion of the belt strap 40 over which it is folded by a hook and loop fastener extending therealong in order to maintain the belt 12 at a desired tightness about the user. A hook element is provided along a side of the folded portion 54 nearest the inside surface 42 of the belt strap 40 with the belt closed and engages with a loop element 56 which extends along an outside surface of the belt strap, opposite the inside surface 42, from near the closure point 46 to near the fold. A second loop element 58 extends along the folded portion 54 on a side opposite the hook element, such that loops of a hook and loop fastener arrangement are provided along nearly the entire perimeter of the belt 12. These loops can be used to engage hooks that may be disposed on an inner surface of an additional belt that may be worn over the belt 12 of the device 10, for example a police duty belt. This engagement allows such an additional belt to be worn simultaneously with the belt 12 of the device 10 without worry that the additional belt may not be adequately supported to remain in place. It should be appreciated that the terms “hook element” and “loop element” as used above refer to a patches of material having suitable characteristics for use as mating halves of a hook and loop fastener.

The belt 12 features front and rear attachment points for selective connection with the attachment elements 34 on the sling 14. The front and rear attachment points are provided by respective rings 60, 62 hung from front and rear portions of the belt strap 40 by hanging straps 64, 66 that are each looped and closed about the belt strap 40. Looped around the belt strap, these hanging straps 64, 66 can be slid along therealong to change their position on the belt 12. The loops of the hanging straps 64, 66 are tight enough around the belt strap 40 to prevent significant rotation thereabout but loose enough to allow sliding motion therealong. As a result, the rings 60, 62 tend to remain below the belt strap 40 even when pulled upon by a significant horizontal force. When worn by a rescuer, the front and rear rings 60, 62 allow connection of the sling 14 in the front or rear depending on the casualty's position and direction in which the rescuer needs to face when pulling the casualty out of harm's way. When the casualty is wearing a belt 12, the rescuer then has the option of two different attachment points for a carabiner 34 to pull the casualty to safety. For example, if a belt-equipped casualty is lying face down, clearly the rear attachment point would be more easily accessible to provide a fast and effective rescue.

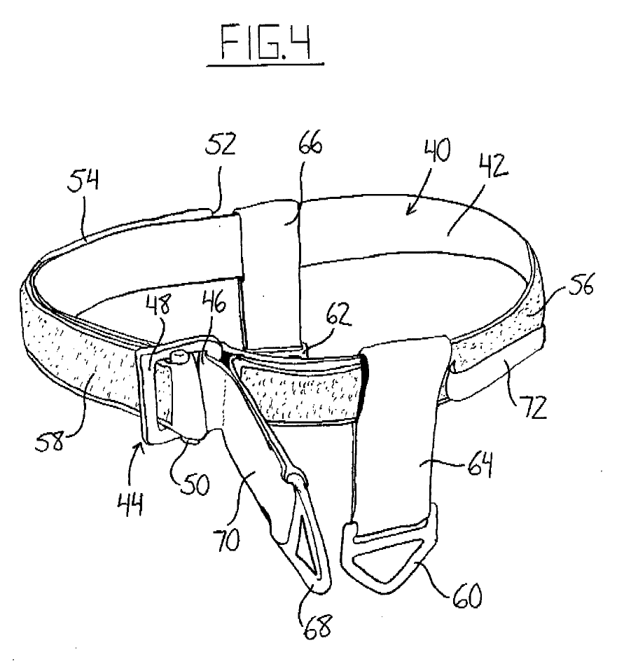

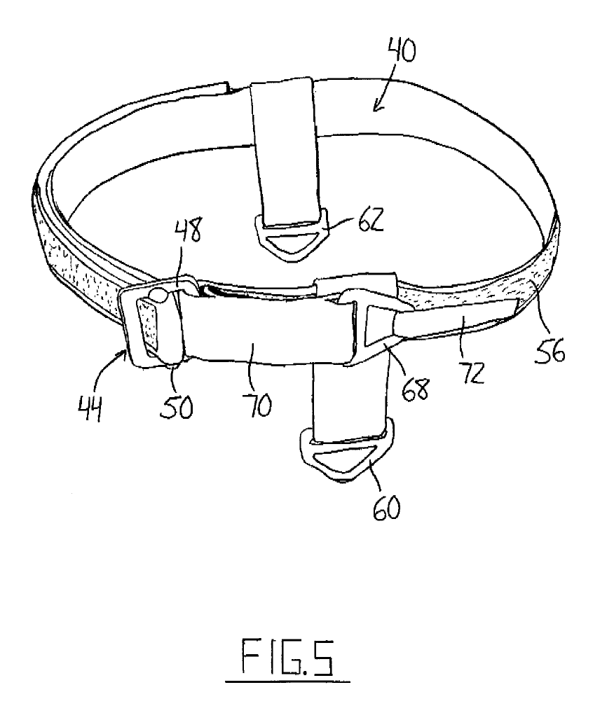

A distal attachment point is provided by a pop out ring 68 supported on an arm 70 for pivoting between a storage position shown in FIG. 5 and a deployed position shown in FIG. 4. The arm 70 is connected to a vertical portion of the buckle's square ring for pivotal motion thereabout. In the storage position, the arm 70 extends along the belt strap 42 and is held in place by an anchor strap 72. The anchor strap 72 is fixedly connected at one end to the outside surface 42 of the belt strap 40 and is detachably connected at the other end to the loop element 56 by a hook element provided on the anchor strap 72. The anchor strap 72 is passed through the pop out ring 68 and then pulled back against the belt strap 40 to engage therewith through the hook and loop fastener arrangement. When it is desirable to use the sling 14, the anchor strap 72 is pulled outward from the belt strap 40 to disengage the hook and loop fastener elements and free the pop out ring 68 for pivotal movement by the arm 70 to the deployed position spaced outwardly from the belt strap 40.

The arm 70 and pop out ring 68 allows connection of the sling 14 and belt 12 at a distance outward from the belt strap 40 so that in the case where an additional belt, such as a police duty belt, is worn over the belt 12 of the device 10, the additional belt doesn't obstruct the attachment point. The sling 14 can be stored on the pop out ring 68 so as not to hang as low as it would if hung from the front or rear attachment rings 60, 62. As such, the sling 14 is kept up and away from the legs of the user and easily deployable for unobstructed use, even while wearing an additional belt over that of the device 10. Supported by the horizontal arm 70, the pop out ring 68 is has a lower tendency to twist the belt strap 40 during exposure to substantially horizontal forces during pulling a casualty along a flat surface than the hanging rings 60, 62.

As shown in the figures, the arm 70 for supporting the pop out ring 68 is formed as an integral extension of the belt strap 40 passed the closure point 46, folded about a portion of the ring 68 and stitched to itself and the belt strap 40. The hanging straps 64, 66 are made in a similar fashion in that each one is folded about the belt strap 40 and respective ring and stitched to itself therebetween.

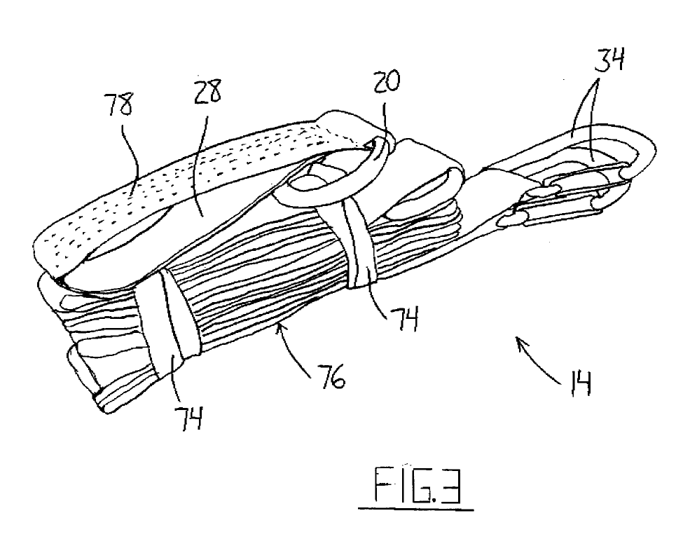

FIGS. 1 and 3 show the sling 14 in a storage condition in which the first and second straps 18 and 32 are folded into a compact arrangement and held in place by a pair of elastic bands 74 extending around the folds 76 and spaced apart therealong. The loop 28, having been reduced to a relatively small size before folding, is not held within the elastic bands and the carabiners extend from the folded sling to allow hanging thereby, for example on the pop out ring 68 of the belt 12. The sling 14 can be quickly unfolded into the deployed condition for use simply by pulling the loop 28 away from the folds 76. The sling 14 is folded so that the carabiners 34 and the loop ring 20 are situated at the same end of the folded sling. As a result, when the carabiners are engaged to a support, such as the pop out ring 68, pulling of the loop 28 away from the folds 76 causes the elastics to slide off the opposite end, thereby freeing the sling to allow its use. As shown in FIG. 3, a reinforced portion 78 of the loop 28 resists bending in order to help prevent reduction of the loop beyond a predetermined size toward collapse. As a result, the loop 28 is sizable but always provides at least a small opening without need for manual opening from a closed state.

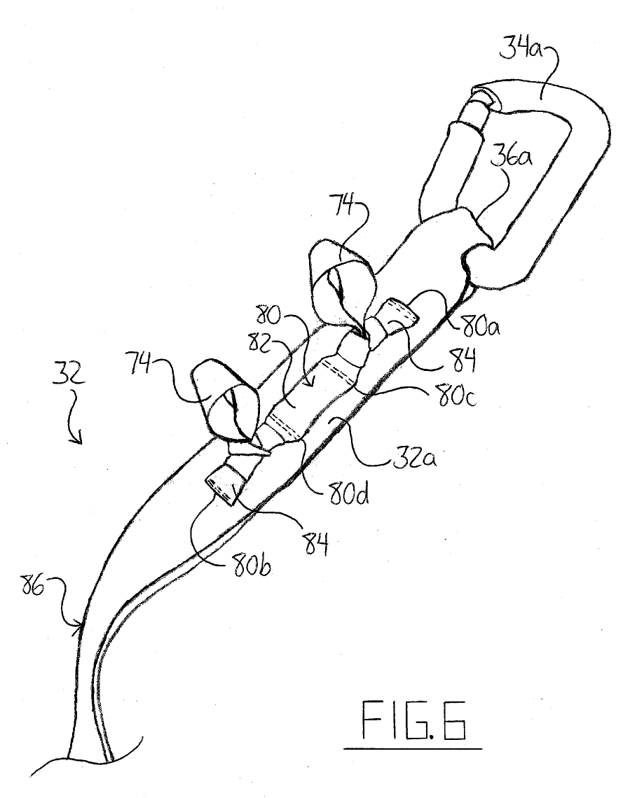

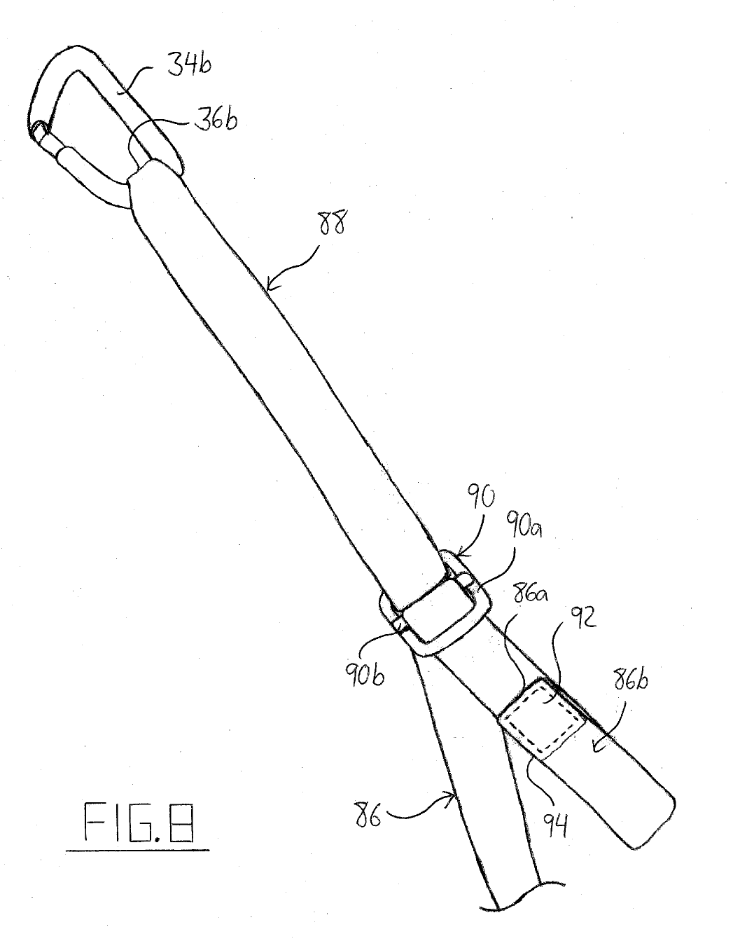

FIGS. 6 to 8 illustrate the second strap of the sling of an extraction device according to a second embodiment of the present invention. The second strap 32 is similar to that of the first embodiment and cooperates with the first strap in the same way, but has some additional features disposed near the carabiners at its opposite ends.

As seen in FIG. 6, a first end 36a of the second strap 32 carries a carabiner 34a like the first embodiment, but a length 32a of the second strap 32 approaching the first end 36a is adapted to carry the elastic bands 74. A strip of webbing 80 narrower than the second strap 32 is situated atop the surface of the length 32a of the second strap proximate the caribiner 24a. Here the strip 80 is stitched widthwise to the second strap 32 adjacent its opposite ends 80a, 80b. The strip 80 is also stitched widthwise to the strap 32 at two spaced apart positions 80c, 80d along its length between and spaced from each of the opposite ends 80a, 80B. Fixed to the second strap 32 at these four points along its length, the strip 80 is divided into three lengthwise sections. A middle section 82 of the strip acts to space apart the two sides sections 84, each of which acts to retain a respective one of the elastics 74. Each elastic band 74 is wrapped around its respective side section 84 of the strip of webbing 80, passed through itself and pulled tight to effectively tie it to the second strap 32. When the device is not being used to extract a casualty, the first and second straps are folded up against the side of the second strap 32 opposite the strip of webbing 80 and the elastics 74 into the storage position, similar to that shown for the first embodiment in FIG. 3. The loops formed by the elastics 74 secured to the strip 80 are passed over the respective ends of the folded straps to hold them in the storage position until such time that they need to be deployed for use. Secured to the second strap 32, when the straps are deployed for use, the elastics are carried with them to prevent loss. This allows the same elastics to be reused without requiring a rescuer to waste attention in a possibly dangerous situation on keeping the elastics in his/her possession.

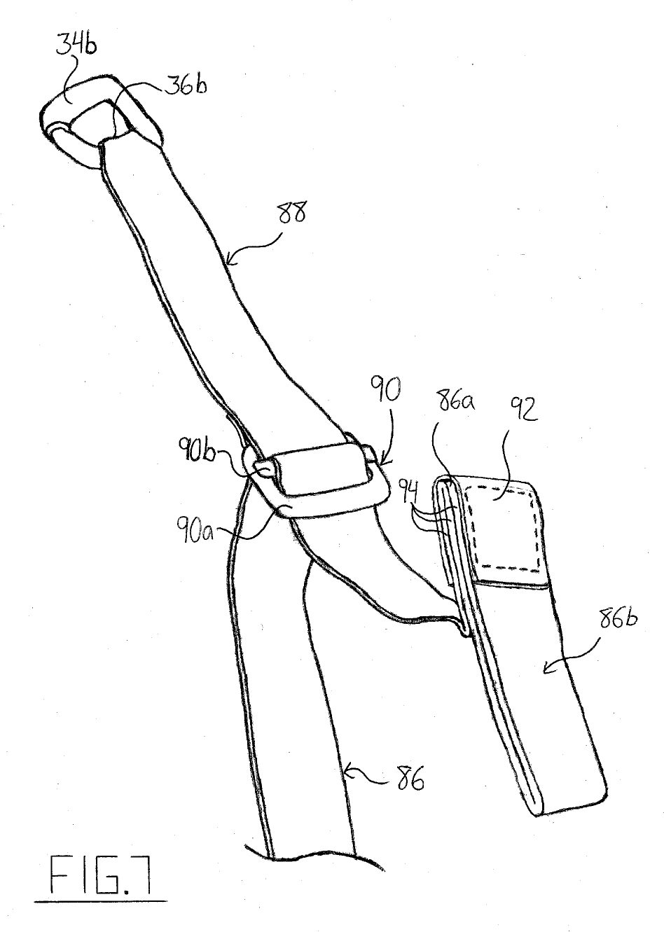

FIG. 7 shows an end of the second strap opposite the first end 36a shown in FIG. 6. From this figure, it can be seen that the so called second strap is not a one piece strap as in the first embodiment, but rather is made up a main piece 86 and an end piece 88 of strapping. A distal end of the end piece 88 defines the second end 36b of the second strap 32 which secures a carabiner 34a like that supported at the opposite first end 36a. The difference between the first and second embodiments leading to the need for a two-piece strap construction is the ability to lengthen and shorten the second strap 32. An end 88a of the end piece 88 of strapping opposite the carabiner 34b is secured to a buckle 90 while an end 86a of the main piece 86 of strapping opposite the carabiner 34a at the first end 36a of the second strap 32 has been passed through the buckle 90 and then adapted to prevent withdrawal back therethrough. A length 86b of the main piece 86 approaching the end 86a thereof has been folded back over itself and sewn into this sandwich-like arrangement with an end cap 92 formed by a swath of material folded over the end 86a of the main piece 86 to encompass the layers 94 formed by the folded end portion 86b. This multi-layer arrangement increases the rigidity of the main piece of strapping at the end portion 86b. This prevents withdrawal of the end 86a of the main piece 86 through the buckle 90, as the folded end portion 86b is longer than the buckle opening and thus cannot fit therethrough without bending, which is resisted by the increased rigidity provided by the folded layers. With the end piece 88 of strapping folded about the ring 90a of the buckle 90 and stitched back onto itself and the main piece 86 fitted through the ring 90a about the cross member 90b of the buckle, pulling on the folded end portion 86b feeds more of the main piece of strapping 86 through the buckle 90 to shorten the length of the second strap 32 between the carabiners 34a, 34b. In other words, this arrangement gives a rescuer the ability to adjust the length of the second strap 32 by altering the length of the main piece of strapping 86 connecting the buckle 90 and the carabiner 34a at the first end 36a.

Rather than having a typical metal-only construction, the carabiners 34a, 34b of the second embodiment are coated with plastic to reduce the amount of noise produced by contact between a carabiner and a metal connection ring, for example those provided on the illustrated belt. When wearing the extraction device of the present invention in a dangerous environment, a person's safety may rely on the ability to carry out operations undetected. Minimizing noise improves the ability to perform operations in stealth to ensure the safety of the wearer and those in his/her company.

It should be appreciated that the present invention may be modified to have rings, attachment elements, buckles, fasteners and straps of different sizes and types known to those of skill in the art. The sling may also feature an additional loop defining strap in order to allow multiple connections to a casualty. The sling and the belt of the device may be sold together or separately, as the sling can be used with other belts or garments providing suitable attachment points and the belt can be used with existing slings or similar device. For example, the belt can be used to extract a casualty with a simple line having carabiners at opposite ends. Similarly, the second strap having attachment elements at its opposite ends may be slidably connected to types of rescue lines other than a sling defining a preformed loop.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. An extraction device comprising:
a sling comprising:
a preformed, closed loop of adaptable size; and
a tightening element extending from the preformed loop;
the preformed loop being reducible in size by pulling of the tightening element.

2. The device according to claim 1 wherein the closed loop is substantially manually unopenable.

3. The device according to claim 1 wherein the closed loop is closed by a substantially rigid member.

4. The device according to claim 1 wherein the preformed loop is defined by a first end of the sling folded toward an opposite second end and adapted for sliding engagement along the sling.

5. The device according to claim 4 wherein the sliding engagement is provided by a substantially rigid member supported at the first end of the sling defining an opening through which the sling passes.

6. The device according to claim 5 wherein further comprising a blocking element supported at the second end of the sling, the blocking element being greater in size than the opening.

7. The device according to claim 1 further comprising at least one attachment element connected to the sling.

8. The device according to claim 1 wherein the sling is foldable into a storage condition from which the sling is deployable by pulling of the preformed loop.

9. The device according to claim 8 comprising at least one elastic member engagable about the sling when folded into the storage condition.

10. The device according to claim 7 wherein the sling and the at least one attachment element are foldable over one another into a storage condition from which the sling and the at least one attachment element are deployable by pulling of the preformed loop.

11. The device according to claim 10 comprising at least one elastic member connected to the at least one attachment element, the at least one elastic member being operable to secure the sling and the at least one attachment element in the storage condition.

12. The device according to claim 1 further comprising a wearable garment, wherein the sling is connectable to the garment to facilitate hands-free pulling of the sling.

13. The device according to claim 1 comprising two attachment elements disposed at opposite ends of a flexible line, wherein the sling comprises a sliding connector engaged to the flexible line and slidable therealong.

14. An extraction device comprising:
a rescue line;
a flexible line having two attachment elements disposed at opposite ends thereof; and
a sliding connection provided between the rescue line and the flexible line to allow sliding along the flexible line of a point at which the flexible line and the rescue line are connected.

15. The device according to claim 14 wherein the flexible line is adjustable to change a distance between the two attachment elements measured along the flexible line.

16. An extraction device comprising:
a rescue line;
an attachment element connected to the rescue line; and
an extraction garment comprising:
a belt; and
a distal attachment point supported an outward distance from the belt for selective connection to the attachment element to facilitate hands-free pulling of the line.

17. The device according to claim 16 wherein the garment comprises additional attachment points provided on front and rear portions of the belt for selective connection to the attachment element.

18. The device according to claim 17 wherein each of the additional attachment points is supported to hang below the belt.

19. The device according to claim 16 wherein the distal attachment point is supported for motion between a storage position adjacent the belt and a deployed position spaced outwardly therefrom.

20. The device according to claim 16 wherein the belt has an outer surface and comprises one of a hook element or a loop element of a hook and loop fastener disposed on said outer surface.
